(19) United States
(12) Patent Application Publication
(10) Pub. No.: US 2008/0277836 A1
(43) Pub. Date: Nov. 13, 2008

(54) METHOD FOR PRODUCING NANO-FIBER WITH UNIFORMITY

(76) Inventor: Jong-Chul Park, Seoul (KR)

Correspondence Address: NIXON & VANDERHYE, PC, 901 NORTH GLEBE ROAD, 11TH FLOOR, ARLINGTON, VA, 22203, US

(21) Appl. No.: 12/098,760

(22) Filed: Apr. 7, 2008

(30) Foreign Application Priority Data
May 7, 2007 (KR) 10-2007-0044037
May 7, 2007 (KR) 10-2007-0044039
Jul. 3, 2007 (KR) 10-2007-0066370
Jan. 11, 2008 (KR) 10-2008-0003648

(51) Int. Cl. B29C 47/00

(52) U.S. Cl. 264/465

(57) ABSTRACT

The present invention relates to a method for the mass-production of nanofiber through electrospinning, particularly to a method for the mass-production of nanofiber having required properties by adjusting the spinning condition of a spinning area in which nozzle blocks and collectors are installed for electrospinning the spinning solution with uniformity. The method for producing nanofiber by electrospinning comprises the steps of determining a spinning area formed by a nozzle block in which a plurality of spinning nozzles are arranged and a collector on which nanofiber are collected; determining factors in adjusting physical properties of nanofiber in the spinning area; and adjusting the determined factors and electrospinning in the spinning area.

### TECHNICAL FIELD

The present invention relates to a method for the mass-production of nanofiber by electrospinning, particularly to a method for the mass-production of nanofiber having required properties by adjusting the spinning condition of a spinning area wherein nozzle blocks and collectors are installed for electrospinning the spinning solution with uniformity.

### BACKGROUND ART

Generally, nanofiber refers to a fiber having an average diameter of 5 to 1,000 nm, which may be applicable to the nanofiber prepared or may be prepared according to the present invention. The nanofiber is usually produced by electrospinning a spinning solution or a melt including polymer. Various techniques for the production of nanofiber have been developed, however, most of them are related to pilot production and the apparatus itself has not been acknowledged to be suitable for the mass-production of nanofiber by electrospinning due to the problems of electric stability and adjustment of properties. The problem of the property adjustment of nanofiber relates to an inhomogeneous spinning of a spinning solution or melt, which may lead to inferiority of the entire product and make it difficult to produce nanofiber having required properties. Korean Patent Publication No. 2005-0077313 discloses an apparatus for electrospinning nanofiber. The object of the prior art is to provide an electrospinning apparatus in bottom-up production process, wherein a plurality of nozzles are arranged in narrow space in order to increase the production per unit time and a nozzle block is formed at the lower end of a collector in order to avoid a droplet phenomenon. In order to achieve the object, the presented conventional art provides a bottom-up electrospinning device, wherein the outlets of nozzles installed on a nozzle block are formed in an upper direction and a collector is located on the top part of the nozzle block. Typically, a voltage as high as about 20 kV should be applied between the nozzle block and the collector for electrospinning fibers. The apparatus according to the prior art, however, comprises complicated electric devices relating to the nozzle block and these devices should be insulated from a high voltage of the nozzle block, which makes it difficult to produce nanofiber in large scale.

Another conventional technique is disclosed in Korean Patent Korean Patent Publication No. 10-0679073. The object of the presented prior art is to provide a method for producing nanofiber in a continuous electrospinning process, wherein a collector is inclined at a certain angle against the ground or nozzles are installed forming a certain angle with the collector in order to avoid forming droplets of spinning solution. This process, however, has a disadvantage that a solvent used during the insulating and spinning processes of electric devices may fall down to spinning nozzles.

U.S. Pat. No. 7,134,857 discloses an apparatus for electrospinning nanofiber conducive to mass production using a rotatable spray head and forming an electric field between collectors which is grounded and an electrospining solution is electrospun to the collector guided by the electric field. This process, however, is not suitable for a continuous process. The adjustment of properties of nanofiber relates to the thickness, the uniformity of the diameter of a produced nanofiber or tensile strength. The adjustment of properties may be determined by adjusting characteristic physical and chemical properties of the spinning solution or melt. In order to produce nanofiber with required properties, above all, the type of polymer and a proper additive to be included in the spinning solution or melt should be determined, which is matter of choice. One of the important factors in adjusting properties of nanofiber is the spinning condition of the spinning area. The spinning area means a space where the spinning solution or melt is electrospun between a nozzle block and a collector. During the process of electrospinning, nanofiber with uniformity may be produced under the same spinning condition. The spinning condition, however, may be affected by an external factor, thus it should be adjustable in order to maintain the condition during the producing process. If the spinning condition is adjustable, it may be possible to produce nanofiber with required properties.

The spinning condition for adjusting properties of nanofiber includes (i) the removal of floating impurities including a volatile solvent in the spinning area; (ii) the gap between a nozzle block and a collector; and (iii) the structure of collector on which nanofiber is collected. The spinning condition may include various factors, but the mentioned three factors should be considered as basic factors. Further, the present invention suggests a method of adjusting these factors.

The object of the present invention is to provide a method for producing nanofiber with uniformity by adjusting the spinning condition during the electrospinning process.

### BRIEF DESCRIPTION OF THE DRAWINGS

The FIG. 1 shows an embodiment of an electrospinning apparatus for treating floating impurities including a volatile solvent.

FIGS. 2(A) and (B) show an embodiment of the method of adjusting the inclination of the nozzle block in order to compensate the variation of thickness in the vertical direction.

FIGS. 3(A) and 3(B) show an embodiment of adjusting the spinning nozzle 121 by the unit line arranged along the process direction of the base material (marked as “M”).

FIGS. 4(A) and 3(B) show an embodiment of adjusting physical properties of the collector according to the present invention.

### DISCLOSURE OF THE INVENTION

According to a preferred embodiment of the present invention, a method for producing nanofiber by electrospinning comprises the steps of determining a spinning area formed by a nozzle block in which a plurality of spinning nozzles are arranged and a collector in which nanofiber are collected; determining factors in adjusting physical properties of nanofiber in the spinning area; and adjusting the determined factors and electrospinning in the spinning area.

According to other preferred embodiment of the present invention, the method for the mass-production of nanofiber by electrospinning comprising the nozzle block in which a plurality of spinning nozzles are arranged and the collector in which nanofiber are collected includes a process of removing gas-type floating impurities including a volatile solvent by inducing an air flow in a regular direction into the spinning area formed by the said nozzle block and the collector.

According to other preferred embodiment of the present invention, the height of nozzle block may be adjusted.

According to other preferred embodiment of the present invention, an assisting base material made of insulating materials is installed on a side of the collector facing the nozzle block.

According to other preferred embodiment of the present invention, the velocity of air flow may be adjusted.

According to other preferred embodiment of the present invention, the method of mass-production of nanofiber includes a process wherein a unit block structure including at least a nozzle block is formed and the height of the nozzle block may be adjusted by each nozzle block or unit block structure.

According to other preferred embodiment of the present invention, the assisting base material is formed with a plurality layers in order to adjust the thickness.

Hereinafter, the present invention will be described in detail with reference to drawings and embodiments. These embodiments are provided only for the illustrative purpose, and it should not be construed that the scope of the invention is limited thereto.

In this description, the spinning area means a place or area where a spinning solution or melt is electrospun under high voltage and the spinning area includes a place between a nozzle block and a collector which may be installed to any form of electrospinning apparatus for producing nanofiber. Further, the nozzle block includes at least one spinning nozzle for maintaining high voltage with a collector and electrospinning a spinning solution or melt, an apparatus or structure to arrange the spinning nozzles; and their accompanying apparatus or structure. Further, the spinning condition includes the type of a spinning solution or melt to produce nanofiber, the voltage between the nozzle block and the collector, the pressure applied from the spinning nozzle to the spinning solution, the temperature of the spinning area or every factor affecting the spinning solution directly or indirectly during the electrospinning process such as a physical properties of the collector and the nozzle block or the properties of a base material.

In producing nanofiber in a small scale, it is easy to maintain consistency in the spinning condition. In producing nanofiber in large scale, however, it is difficult to maintain its consistency in the spinning condition of the entire apparatus or the entire spinning area. The adjustment of spinning condition for the mass-production of nanofiber means the adjustment of factors in affecting the spinning area. There are various factors in affecting the spinning condition of the spinning area, but basically, the factors include (i) the removal of floating impurities including a volatile solvent in the spinning area; (ii) the gap between a nozzle block and a collector; and (iii) the structure of collector on which nanofiber is collected. In order to produce nanofiber in large scale by electrospinning, the factors related to (i) to (iii) should be properly adjusted first. Other factors such as the surface area of a collector corresponding to the surface area of a nozzle block and the number of spinning nozzles installed to the nozzle block also should be basically determined, but these factors are pre-determined by the production size or the strength of spinning voltage and, therefore, they are excluded from the controllable spinning condition of the present invention. In this description, the control of the spinning condition means the adjustment of the controllable factors according to the pre-determined surface area of the nozzle block, the surface area of the collector and the number of spinning nozzles, or it means a controllable factor, regardless of those pre-determined factors, applied in the present invention.

Hereinafter, a method for adjusting the three basic factors will be described in detail.

The FIG. 1 shows an embodiment of an electrospinning apparatus for treating floating impurities including a volatile solvent.

The electrospinning apparatus comprises a collector 11 on which a nanofiber web is collected; a nozzle block 12 on which a spinning nozzle 121 is arranged and which is installed under the collector 11; and a fixing table (T) to install the nozzle block 12. The electrospinning apparatus for producing nanofiber includes a voltage source which maintains a voltage difference of 1 kV to 30 kV between the collector 11 and the nozzle block 12 or a solution feeder to supply a spinning solution, but such a known apparatus which does not required for a clear understanding of the present invention is not shown or described in this description. However, this does not means that such a apparatus does not used in the embodiment of the present invention.

In the present invention, a means or an apparatus for adjusting the spinning condition based on any known electrospinning apparatus is added. Thus, it should be understood that such apparatus is not shown or described for easy understanding of the present invention, but included in this present invention.

In the process of electrospinning of the spinning melt or solution, some of spinning melt or solution may remain in the spinning area and the accumulation of such residues may change the spinning condition and obstruct the uniform spinning. If the residues are electrically charged, the electrospinning may be unstable and, as a result, it may seriously damage the quality of the produced nanofiber. Thus, the residues which may affect the spinning condition should be removed immediately once it is produced. The residues may be divided into a liquid-type residue falling down on the surface of the nozzle block 12 and a gas-type residue floating in the spinning area. Among them, the gas-type residue floating in the spinning area such as a volatile solvent mainly affects the spinning condition. The liquid-type residue may be removed by an additional means and the gas-type residue may be removed by installing a blower 13 and an inhaler 14. The blower 13 has a function of filtering or introducing a purified air into the spinning area and the inhaler 14 has a function of flowing out the introduced air from the blower 13 together with the gas-type residue. Thus, the blower 13 and the inhaler 14 may produce air flow in a regular direction within the spinning area. The blower 13 may include e.g. a rotating blower operated by a motor and a filter for purifying air. The blower 13 and the inhaler 14 may have any structure capable of producing air flow within the spinning area and may be installed in any location, but preferably located as shown in the FIG. 1. In the case of a rectangular-shaped nozzle block 12, the blower 13 is installed along one edge of the nozzle block 12 and the inhaler 14 is installed along the opposite edge, such that the blower 13 and the inhaler 14 are formed on two walls facing each other. Along the rest two edges of the nozzle block, two screens 15a, 15b are installed such that the blower 13, the inhaler 14 and the two screens 15a, 15b form a rectangular-shaped wall. The collector 11 installed over the nozzle block 12 is formed to cover the rectangular-shaped wall. In this manner, the spinning area is covered up. In this description, the covered-up area does not mean that the area completely cut off the inflow and outflow of air. Rather, it means that the spinning area may be structurally divided as one separate place or area. The blower 13, the inhaler 14 and the screens 15a, 15b may be made of insulating materials of e.g. plastic or resin material.

The blower 13 includes a structure capable of adjusting the amount and the direction of air flow. In order to adjust the amount and the direction of air flow, as shown in FIG. 1 (marked “A”), the blower 13 includes a plurality of blinds (131) which may be opened and closed. The blind 131 is installed to be rotatable by a rotating roller 133 installed at a certain position of two supporting posts 132 and the amount and the direction of air flow may be adjustable by a rotating angle AN of the blind 131.

The inhaler 14 may be connected to a reservoir 16 with an outlet OUT to which a solution is discharged through a pipe P. In the reservoir 16, if necessary, a rotating wing 161 may be installed such that air flow in the spinning area may be induced. The gas-type residue in the spinning area is transferred to the reservoir 16 by the air flow and discharged outside through the outlet OUT to be properly treated.

Other factor which should be considered for a uniformed spinning is the spinning gap between the nozzle block and the collector. The adjustment of the spinning gap means the adjustment of gap between nozzle block and the collector. Strictly speaking, however, in this description, it means the adjustment of the distance between the spinning nozzle and the collector. The distance between the spinning nozzle and the collector is pre-determined during the process of designing the electrospinning apparatus. It is, however, necessary to adjust the spinning distance during the producing process of nanofiber. For example, if the thickness of nanofiber to be collected on the base material is different, the overall spinning gap should be adjusted. In this case, the height of the fixing table on which nozzle blocks are installed is adjusted in order to adjust the spinning gap and thereby the thickness of produced nanofiber may be adjusted. The variation of thickness may occur in the vertical direction of the process direction of the base material, which may be compensated by adjusting the inclination degree of the nozzle block.

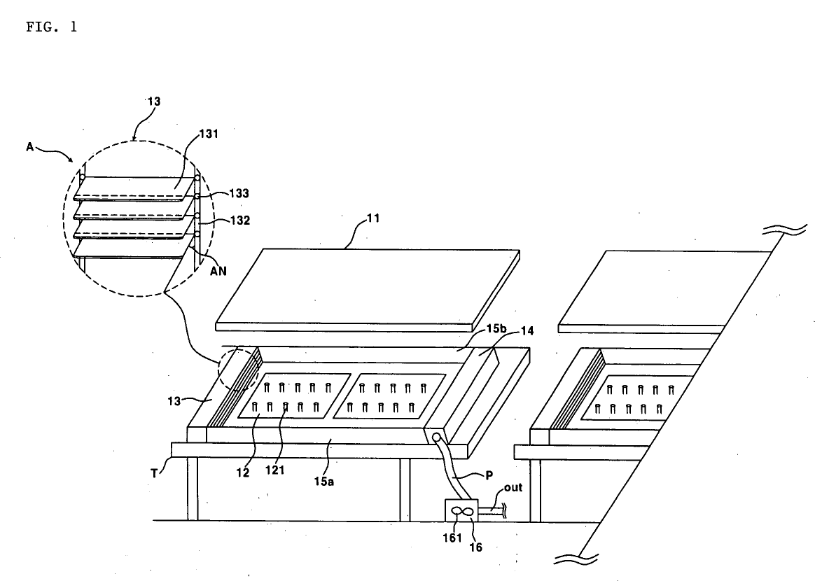

FIGS. 2(A) and (B) show an embodiment of the method of adjusting the inclination of the nozzle block in order to compensate the variation of thickness in the vertical direction.

A plurality of nozzle blocks 12a, 12b, 12c may form one unit and then form a unit block structure 21. The unit block structure 21 may include at least a nozzle block and the electrospinning apparatus may include at least a unit block structure 21 installed along the process direction M of the base material. Each unit block structure 21 is installed on the fixing table 22 and the height of the fixing table 22 is adjustable. In order to adjust the height of the fixing table 22, a supporting pad 221 made of synthetic resins or rubber-type materials on the bottom surface of the fixing table 22 and the supporting pad 221 is connected to a table leg 223 by a screw for adjusting the height 222. The height of the table leg 223 is adjusted by moving the screw 222 up and down, but any means for adjusting the height disclosed in this field may be used to adjust the height of the fixing table 22. The number of table legs 223 may be any number, but in the case of a rectangular-shaped unit block 21, four table legs 223 may be installed at each edge.

The spinning gap may be adjusted not only by the unit block structure 21, but also by each nozzle block 12a, 12b, 12c. In order to adjust the height of each nozzle block 12a, 12b, 12c, a means for adjusting height may be installed at a per-determined position A1, A2, A3 of nozzle blocks.

The FIG. 2(B) shows a cross-section of FIG. 2(A) cut off along the line (marked as “S-S”).

The nozzle blocks 12a, 12b, 12c have a means for adjusting height 23a, 23b, 23c installed at the positions marked A1, A2 and A3). The means for adjusting height 23a, 23b, 23c may be installed as a screw-type, but any means for adjusting the height disclosed in this field may be used for adjusting the height of the nozzle block 12a, 12b, 12c.

Unlike the embodiment presented in FIG. 2(A) or (B), the height of the spinning nozzle formed at a certain position of the nozzle block may be adjusted.

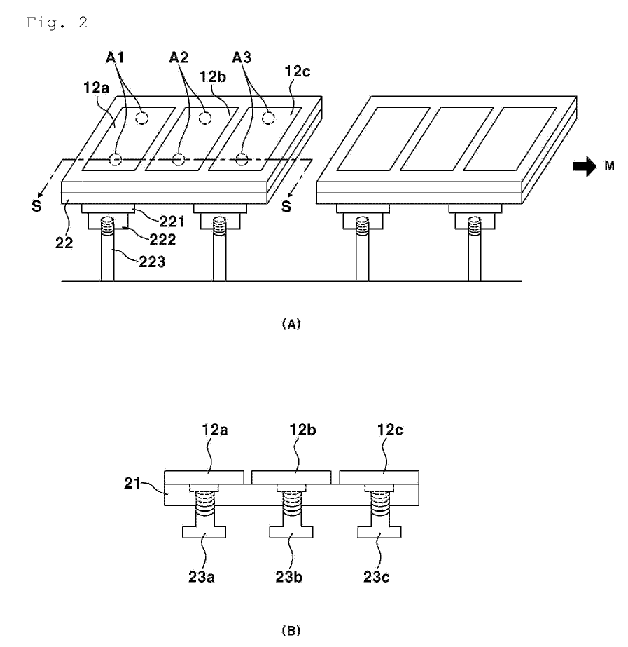

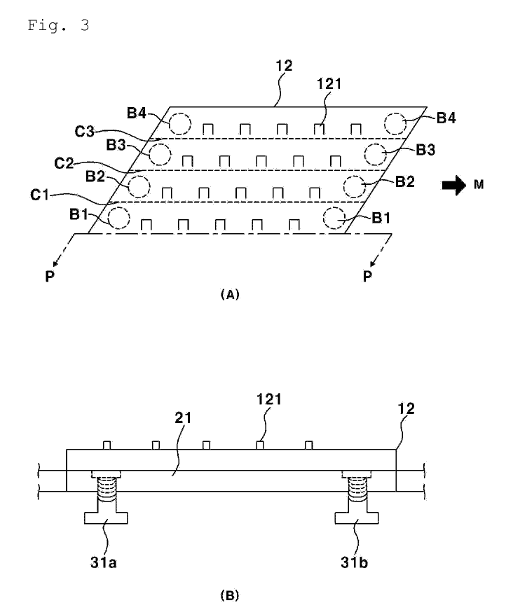

FIGS. 3(A) and (B) show an embodiment of adjusting the spinning nozzle (121) by the unit line arranged along the process direction of the base material (marked as “M”).

The nozzle block 12 is formed to be able to adjust the height by the unit of spinning nozzle 121 arranged along the process direction M of the base material which is separately marked as C1, C2 and C3. In the FIG. 3(A), a plurality of blocks arranged on the same line such that the height of nozzle blocks may be adjusted by unit line, but it is possible to form a block such that at least a line may be separated. In order to adjust the height of each unit block, a device for adjusting the height is installed at both ends (B1, B2, B3, B4) of the unit block. The FIG. 3(B) shows a cross-section of the FIG. 3(A) cut off along a line (marked as “P-P”). At least a nozzle block 12 is installed in the unit block structure 21 and the devices for adjusting the height 31a, 31b formed as a screw-type are passed through the unit block structure 21 such that the height of the spinning nozzle 121 may be adjusted by the unit line along the process direction M of the base material. The devices for adjusting the height 31a, 31b may be formed in any manner for adjusting the height disclosed in this field and installed at any position capable of adjusting the height of each separated nozzle block.

Another factor for adjusting the spinning condition is physical properties of the collector.

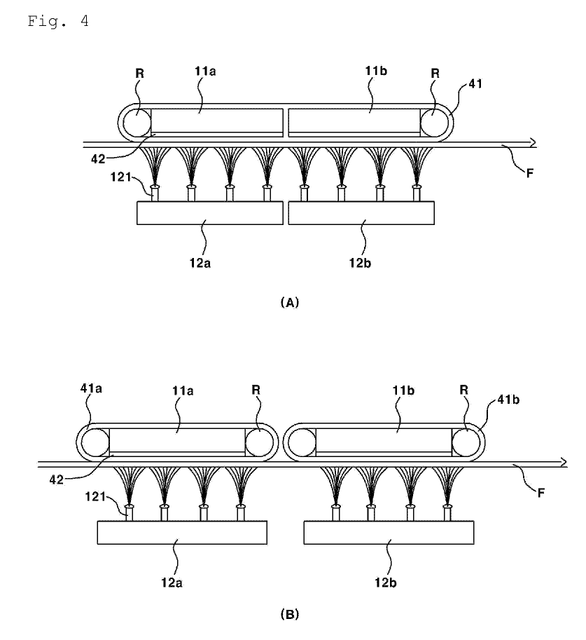

FIGS. 4(A) and (B) show an embodiment of adjusting physical properties of the collector according to the present invention.

As shown in FIG. 4(A) or (B), a plurality of collectors 11a, 11b are operated by a pair of rotating rollers R and rotating belts 41 or each collector 11a, 11b may be operated by each of the pair of rotating rollers R and rotating belts 41a, 41b. The thickness of nanofiber collected on the base material F after being spun by the spinning nozzle 121 installed on the nozzle block 12a, 12b is affected by the velocity of the partial movement of the base material F or the tension caused by the rotating roller R. In the process of producing nanofiber, the shape of rotating belts R affects the base material F and thereby it may disadvantageously affect the form of collecting nanofiber.

This is the main problem in the case of using a single pair of rotating rollers R as shown in FIG. 4(A). Generally, in the case of employing a plural pairs of rotating rollers R, the tension applied to the base material is increased. Further, when the rotating belts 41 are operated by a single pair of rotating roller R, the stickiness of the base material F against the rotating belt 41 is improved. Further, the choice of the pair of the rotating roller R should be determined considering the tension and the thickness required according to the type of the base material F and the nanofiber. Thus, once the pair of rotating roller R is determined, it is necessary to adjust, if required, the stickiness and the tension.

In order to adjust the tension and the stickiness, an assisting base material 42 may be attached under the collector. The assisting base material 42 should have different physical materials from the collectors 11a, 11b and, thus made of insulating materials. The assisting base material 42 may be made of e.g. cellulose, cellulose derivatives or polymers, or it may be made of their compounds such as any form of a natural fiber, a regenerated fiber, a synthetic fiber, a nonwoven fabric or a resin. Further, the assisting base material 42 may be formed as a plate- or a disk-type with the corresponding size to the collector 11a, 11b. Alternatively, a plurality of layers of the assisting base material 42 may be formed, and each layer of the assisting base material 42 may be made of the same material or different material. The assisting base material may be found with a plurality of layers in order to adjust the thickness. The adjustment of the thickness of the assisting base material 42 may be determined by the type of the base material F and nanofiber and further, it may be determined by measuring the thickness of the nanofiber in real time during the producing process. The thickness of the nanofiber may be determined by measuring the ability of ventilation by the cubic feed per minute (CFM).

While the present invention is described with reference to particular embodiments thereof, it will be understood by those skilled in the art that variations or amendment may be made therein without departing from the sprit and scope of the invention. The scope of the present invention is not limited by those variations or amendments, but by the following claims.

### EFFECTS OF INVENTION

The present invention has an advantage of producing nanofiber with uniformity. Further, according to the present invention, nanofiber having required physical properties may be produced by adjusting the spinning condition.

1. A method for producing nanofiber by electrospinning comprising the steps of:
determining a spinning area formed by a nozzle block in which a plurality of spinning nozzles are arranged and a collector on which nanofiber are collected;
determining a factor in adjusting physical properties of nanofiber in the spinning area; and
adjusting the determined factors and electrospinning in the spinning area.

2. The method for producing nanofiber according to claim 1, wherein the factor is the existence of floating substances including a volatile solvent.

3. The method for producing nanofiber according to claim 1, wherein the factor is the spinning gap between the nozzle block and the collector.

4. The method for producing nanofiber according to claim 1, wherein the factor is the structure of the collector on which nanofiber are collected.

5. The method for producing nanofiber according to claim 2, wherein the factor is the spinning gap between the nozzle block and the collector.

6. The method for producing nanofiber according to claim 2, wherein the factor is the structure of the collector on which nanofiber are collected.

7. The method for producing nanofiber according to claim 2, wherein the floating substance including a volatile solvent is removed by producing air flow within the spinning area.

8. The method for producing nanofiber according to claim 3, wherein the spinning gap between the nozzle block and the collector is adjusted by changing the height of the nozzle block.

9. The method for producing nanofiber according to claim 4, wherein the structure of collector is determined by installing an assisting base material made of insulating materials on the surface of the collector on which nanofiber are collected.

10. The method for the mass-production of nanofiber by electrospinning comprising the nozzle block in which a plurality of spinning nozzles are arranged and the collector on which nanofiber are collected, characterized by
including a process of removing gas-type floating substances including a volatile solvent by inducing an air flow in a regular direction into the spinning area formed by the said nozzle block and the collector.

11. The method for the mass-production of nanofiber according to claim 10, wherein the height of the nozzle block may be adjusted.

12. The method for producing nanofiber according to claim 10, wherein the assisting base material made of insulating materials is installed on a side of collector facing the nozzle block.

13. The method for producing nanofiber according to claim 10, wherein the velocity of air flow is adjustable.

14. The method for producing nanofiber according to claim 11, wherein a unit block structure including at least a nozzle block is formed and the height of the nozzle block may be adjusted by each nozzle block or unit block structure.

15. The method for producing nanofiber according to claim 12, wherein the assisting base material is formed with a plurality of layers in order to adjust the thickness.
